(19) United States
(12) Patent Application Publication
(10) Pub. No.: US 2006/0185478 A1
(43) Pub. Date: Aug. 24, 2006

(54) Locking tweezers for securing nuts or head bolts

(76) Inventor: Thomas Trozera, Del Mar, CA (US)

Correspondence Address: MICHAEL E. KLICPERA, PO BOX 573, LA JOLLA, CA, 92038-0573, US

(21) Appl. No.: 11/327,858

(22) Filed: Jan. 9, 2006

Related U.S. Application Data
(60) Provisional application No. 60/656,234, filed on Feb. 24, 2005.

(51) Int. Cl. B25B 9/00; B25B 9/02; B25B 7/00

(52) U.S. Cl. 81/13; 294/99.2

(57) ABSTRACT

Nut or bolt head holding tweezers which are engageable with nut or bolt heads and is formed from either metallic or polymeric material and includes a pair of substantially parallel legs that extend from a proximal joint end. One of the legs of the nut or bolt head tweezers is formed with partial polygonal jaw with the other leg having an opposing partial polygonal jaw. Furthermore, the tweezers are fitted with a locking slide that when moved in the distal direction, flexing said legs together and secures the nut or bolt head between said partial polygonal jaws. Thereby facilitating the ability to successfully secure and position a nut or bolt in an area with difficult accessibility.

### PRIOR APPLICATIONS

This application claims priority from U.S. provisional application No. 60/656,234, filed on Feb. 24, 2005, the entire contents of which are incorporated herein by reference.

### FIELD OF THE INVENTION

The present invention pertains generally to nut or head bolt holding tools. More particularly, the present invention pertains to a specifically configured pair of tweezers that function to effectively assist one holding a nut or head bolt or other similar items, to provide leverage support means for holding nuts or head bolts in areas having difficult accessibility.

### BACKGROUND OF THE INVENTION

The use of general pliers, tweezers or other tools for the purposes of holding and retaining one jaw (e.g. nut or head bolt) relative to another body (e.g. an opposing nut or head bolt) has been widely practiced for some time.

In many applications it is desirable that a stable fastening means against which a component, such as a nut or bolt head, can be positioned and held stationary in difficult accessibility situation such as behind walls or obscured from view. To accomplish this, however, it is necessary for the operator using standard tools to maintain hand or finger pressure on the handle end of the pliers, or use a mechanism to increase the physical size to hold a nut or bolt head in tight area or area with difficult accessibility. These standard applications generally have certain characteristics that do not allow an operator to access and hold a nut or bolt head in a specific position in an area with difficult accessibility, such as behind walls or tight areas. While the pliers or tweezers are engaged with the nut or bolt head, the present invention is used to facilitate holding and positioning a secured nut or bolt head in an area with difficult accessibility.

In addition to the functional considerations mentioned above, it is also of practical importance that the tweezers be easily engaged with and disengaged from the particular nut or bolt head with which it cooperates. The preferred method for maintaining engagement, of course, would, be a one-step locking operation wherein the legs of the tweezers are flexed towards each other, forcing the distal holding means to engage a nut or bolt head.

Likewise, the preferred method for disengagement would be effectively another one-step operation. The present invention incorporates a sliding locking mechanism which flexes the legs towards each other when moved to its distal direction and un-flexes the legs when the moved to its proximal position. The tweezers may also be disengaged by pulling toward the operator thereby flexing the distal ends in an outward direction and causing a release without moving the slide lock.

In light of the above, it is an object of the present invention to provide lockable tweezers for holding a nut or bolt head to facilitate the holding and securing of the nut or bolt head in areas with difficult accessibility.

It is another object of the present invention to provide a locking mechanism which can be slid distally or proximately along the pair of legs in a one-step operation.

Still another object of the present invention is to provide lockable tweezers for holding and securing nuts or bolt heads that are relatively easy to manufacture, provide holding and positioning of a nut or bolt head in areas with difficult accessibilities.

### SUMMARY OF THE PREFERRED EMBODIMENTS

A lockable tweezer for holding and supporting standard square, pentagon, hexagon or in generally, typical multi-polygonal shaped nuts and bolt heads comprising a pair of flexible legs which extend generally parallel to each other that are joined at their proximal (upper) ends. Each leg has a partial polygonal jaw formed at the distal ends opposite the proximal end. Further, the legs are flexed such that the partial polygonal jaws do not engage each other, forming a gap between, in its open, relaxed state. As intended for the present invention, in order to engage and secure the nut or bolt head with the partial polygonal jaws, the polygonal objects must be positioned within the gap and between the partial polygonal jaws of the tweezers. A locking slide is moved from its proximal position to its distal position, causing the legs of the tweezers to flex and move towards each other, closing the gap. As a result of moving the slide to its distal locking position, the partial polygonal jaws encase and become firmly engaged with the nut or bolt head. As intended for the present invention, the engagement of the tweezers with the nut or bolt head is accomplished in a lockable, one-step, operation. The particular structure of the tweezers makes this possible.

At their respective ends, opposite the proximal ends, each leg of the tweezers is formed with a partial polygonal jaw. For example, each partial polygonal jaw is formed by a first upward bend section having an approximately 120 degree angle, from the longitudinal axis of the tweezers shaft, and a second downwardly bend section that has an approximately 120 degree angle from the upward bent. This configuration generally is designed to match the polygonal dimensions of a variety of nuts and bolt heads. This angle may be varied to suit the specific application

The present invention includes an extended handle portion that serves to effectively extend the range of length that typical operators can hold a nut or bolt head in specific position in areas of difficult accessibility. The proximal end of the handle portion can be fitted with a means to attached additional extension pieces for extending the overall length of the tweezers.

In the operation of the nut or bolt head holding tweezers of the present invention, the nut or bolt head is located and positioned within a gap between the partial polygonal configurations. While holding the nut or bolt head between the partial polygonal shaped jaws, the locking mechanism is moved from its proximal position to its distal position, causing the flexible legs to move towards each other and close the gap. At this locked position, the nut or bolt head is engaged with the partial polygonal shaped jaws.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the nut or bolt head holding tweezers of the present invention engaging a nut or bolt with the locking slide in the distal position in an area with difficult accessibility.

FIG. 2 is a side view of the present invention as seen in FIG. 1 with the screw or bolt penetrating a hole in a wall with its distal treaded end engaging a nut secured between the partial polygonal jaw.

FIG. 3 is an angled side view of second embodiment of the nut or bolt head holding tweezers demonstrating a sliding pin mechanism in the distal position securing the nut or bolt head within the partial polygonal jaws.

FIG. 4 is a side view of third embodiment of the nut or bolt head holding tweezers demonstrating a leg biasing mechanism that is securing the nut or bolt head within the partial polygonal jaws.

### DESCRIPTION OF THE PREFERRED EMBODIMENTS

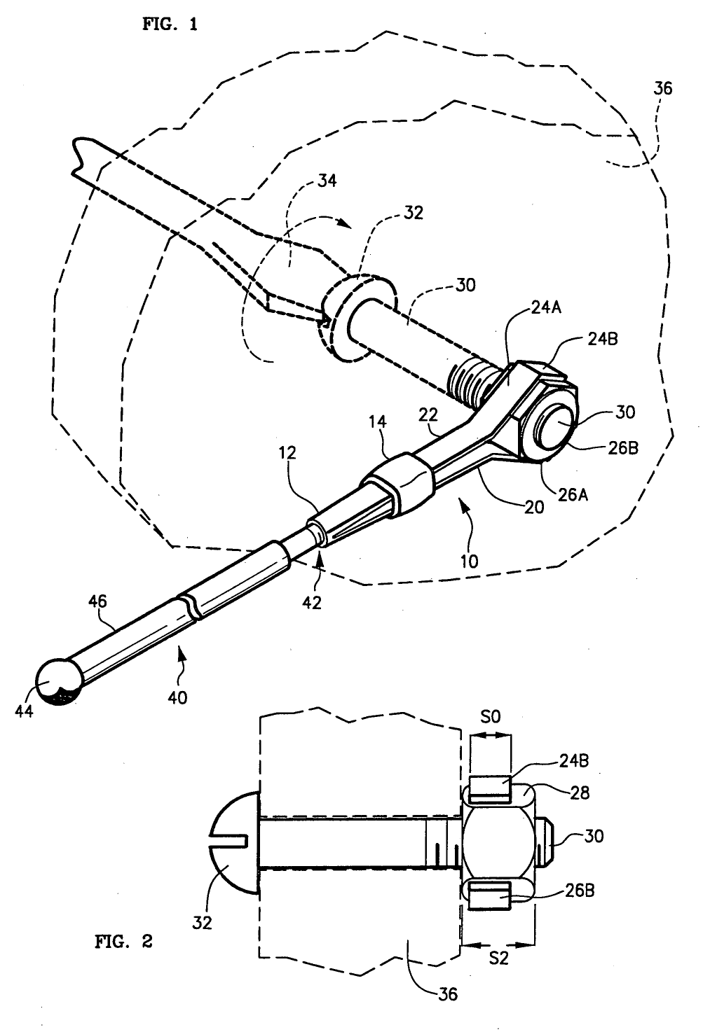

FIG. 1 shows a perspective view of the nut or bolt head holding tweezers 10 engaging a nut or bolt head 28 with a securing means 24 A,B and 26 A,B. The tweezers 10 maintain engagement by using a locking slide that is in a distal position. FIG. 1 demonstrates using the present invention behind a wall section 36 representing an area with difficult accessibility. It is not uncustomary for mechanics to have trouble holding and securing nuts or bolt heads in difficult areas, such as behind walls, in awkward positions, or obscured from visual observation.

As seen in FIG. 1, the nut or bolt head holding tweezers 10 are engaged with hexagonal nut 28 by partial polygonal jaws 24 A,B and 26 A,B. Lockingjaw 14 is in its distal position and is forcing the legs of the tweezers towards each other. The tweezers will facilitate holding and positioning nuts and bolt heads in areas of difficult accessibility for threading and tightening operations. It has been found that in certain devices and structures, such as airplanes, cars, tractors, homes etc. all have areas of difficult accessibility where the present invention functions to allow threading and tightening operations not normally possible.

The purpose for engaging the nut or bolt head 28 holding tweezers 10, as illustrated in FIG. 1, is to facilitate holding and maintaining the nut or bolt head 12 in a desired position relative to the a screw or bolt 30 that is behind a wall structure 36 and difficult to access.

The specific details of the nut or bolt head holding tweezers 10 will be further appreciated by reference to FIGS. 1 and 2. For purposes of the present invention, the polymeric or metallic material that is to be used for the legs 20 and 22 can be made of any material which has sufficient strength and flexibility to perform the functions required for operation of the nut or bolt head holding tweezers 10. Preferably the legs are comprised of a spring steel or similar polymer, enabling then to be flexed together to the position shown in FIG. 1 and then released to spread apart and form a gap for inserting a nut or bolt head between the opposing partial polygonal jaws. The resistance to flexing is of course determined not only by the gauge and physical characteristics of the material used, but also by the width of each leg 31. It is anticipated by the Applicant that composite structures, such as metallic legs with polymeric jaws.

Legs 20 and 22 are joined together at their upper proximal end 12, as by forming them integrally from a single piece of metal or plastic. The proximal end 12 of the tweezers 10 can be fitted with a male or female threaded section. Either formed as an integral portion or as individual structures, a pair of partial polygonal jaws formed by bend sections 24a and 24b on one side and bend sections 26a and 26b on the other opposing side. The size and length of the partial polygonal jaws can be varied to accommodate small and large nut and bolts accordingly.

Legs 20 and 22 are also configured to include arcuate camming portions to allow the legs to attain an open and closed position. Engaged over the legs and arcuate camming portions is a locking slide 14 with a rectangular opening designed to receive legs 20 and 22. Locking slide 14 can be fabricated from either a preferred polymeric or an alternate metallic material. The polymeric or metallic material that is to be used for locking slide 14 can be made of any material that has sufficient strength and a low coefficient of friction to perform the functions required for operation of the nut or bolt head holding tweezers 10. For purposes of disclosure here, upper end 12 will sometimes be referred to as being at the proximal end and the separated ends near partial polygonal jaws 20 and 22 referred to as being at the distal end of the tweezers 10. Closure and locking of the gap between the legs is facilitated by moving slide 14 from its unbiased proximal position to its distal locking position. It is equally important, however, that the legs 20 and 22 be able to return to the relaxed, unstressed configuration allowing insertion of a nut or bolt head 28. This ability to return to the unstressed relaxed configuration is facilitated by the resilience of the legs 20 and 22. Therefore, moving the locking slide 14 to its proximal position allows the legs to spread apart and assume their normal, open position.

FIG. 1 also demonstrates an extension means which engages and secures extension section 40 to the proximal end 12 of the nut and bolt head holding tweezers 10. The extension section 40 comprises a rod or shaft 46 and a terminating distal end 44. The proximal end 12 of the nut and bolt head holding tweezers 10 is designed to receive the proximal end extension 42 which in FIG. 1, shows a male threaded proximal end 42 engaged to a female threaded receiving end. A nut could be added to the male threaded section to further secure the shaft 46 to the proximal section 12. Other means of engagement are anticipated by the Applicant, such as press fit or snap fit technology. In addition, the proximal terminal end 44 can be fashioned to have a rod or “T” extending to provide additional proximal support.

Preferably the extension 40 is comprised of a light weight rigid material such as either polymer or spring steel, enabling the extension to effectively lengthen the control of the remote secured tweezers 10.

Exact values for the dimensions for the many of structures described in this specification are unimportant. What matters for some are their relative values. The relative dimension and the size of the bend sections 24A, 24B and 26A, 26B should accommodate the size of the nut or bolt head that is to be engaged. Also, bend angle sections can have angles other than 120 degrees to better accommodate square, hexagon, or other nut and bolt heads. In addition, the length of rectangular opening of lockable slide 32 must be dimensioned to closely fit the width 48 of the tweezers 10. Furthermore, the width of rectangular opening of lockable slide 32 must be dimensioned to closely ride over arcuate camming surface 28a and 28b to force the legs 22a and 22b towards each other.

FIG. 2 is a side view of the present invention as seen in FIG. 1 with the screw or bolt penetrating a hole in a wall with its distal treaded end engaging a nut secured between the partial polygonal jaws. It can be seen the screw head 32 is engaged to one side of the wall 36 with its shaft 30 penetrating the wall and a nut 28 engaging the other side of the wall 36. Also demonstrated is that the width of the partial polygonal jaw S0, as shown by upper bend section 24B and lower bend section 26B is less than the width S2 of the hexagonal nut 28.

FIG. 3 is an angled side view of second embodiment of the nut or bolt head holding tweezers 60 demonstrating a sliding pin mechanism in the distal position securing the nut or bolt head within the partial polygonal jaws. Instead of the locking slide mechanism 14 of the primary embodiment, this second embodiment utilizes a sliding pin 64 which is inserted within a slot 62 in both legs 20 and 22. Closure and locking of the gap between the legs 20 and 22 is facilitated by moving sliding pin 64 from its unbiased proximal position to its distal locking position. It is equally important, however, that the legs 20 and 22 be able to return to the relaxed, unstressed configuration allowing insertion of a nut or bolt head 28. This ability to return to the unstressed relaxed configuration is facilitated by the resilience of the legs 20 and 22. Therefore, moving the slide pin 64 to its proximal position allows the legs to spread apart and assume their normal, open position.

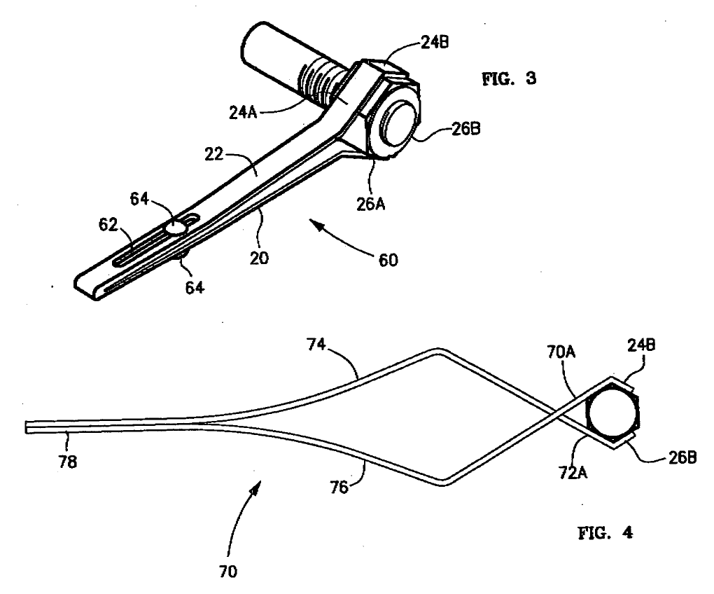

FIG. 4 is a side view of third embodiment of the nut or bolt head holding tweezers demonstrating a leg biasing mechanism that is securing the nut or bolt head within the partial polygonal jaws. Instead of the locking slide mechanism 14 of the primary embodiment or the sliding pin 64 of the second embodiment, this third embodiment relies solely on the biased strength of the legs together with a configuration which opens the gap by applying inward pressure to legs 74 and 76. Closure and locking of the gap between the legs 20 and 22 is facilitated by generating inward pressure on the outside surface of legs 20 and 22 which moves tweezers 70 into a locking position. It is equally important, however, that the legs 20 and 22 be able to return to the relaxed, unstressed configuration allowing insertion of a nut or bolt head 28. This ability to return to the unstressed relaxed configuration is facilitated by releasing the inward pressure on legs 20 and 22 and the resilience of the legs 20 and 22. Therefore, simply releasing the pressure on the outside surface of the legs 20 and 22 allows the legs to spread apart and assume their normal, open position.

### OPERATION

In the operation of the nut or bolt head holding tweezers 10 of the present invention, the nut or bolt head 28 is first positioned within the aperture or gap between holding means 24 A,B and 26 A,B as shown in FIG. 1. The locking slide 14 is then advanced towards the distal position forcing the legs 20 and 22 towards each other and firmly engaging nut or bolt head between the holding means.

The tweezers 10, 60, 70 now can be guided such that the nut or bolt head can be positioned in an area with difficult accessibility, as perceptively shown in FIGS. 1 and 2. Once nut or bolt head is positioned, an opposing screw is either threaded into or removed from the nut or bolt head.

While the particular nut or bolt head holding tweezers 10, 60, 70 as herein shown and disclosed in detail are fully capable of retaining the objects and providing the advantages herein before stated, it is to be understood that it is merely illustrative of the presently preferred embodiments of the invention and that no limitations are intended to the details of construction or design herein shown other than as described in the appended claims.

I claim:

1. Tweezers for holding and positioning a nut or bolt head comprising:
a pair of flexible legs fixedly joined at their proximal ends, each said leg having a terminal end opposite a proximal joint, a first leg having a first end having a first partial polygonal jaw and a second leg having a second end having a second partial polygonal jaw;
said partial polygonal jaws comprising a plurality of bend sections, said bend sections result in a configuration that forms around at least two sides of a nut or bolt head, said tweezers having the function to hold and secure said nuts or bolt heads in areas of difficult accessibility;
arcuate camming surfaces on the outside of said legs, and;
a locking slide embracing said legs to slidably engage said arcuate camming surfaces so that when moved from a proximal position to a distal position, said locking mechanism flexes said legs together.

2. Tweezers for holding and positioning a nut or bolt head as recited in claim 1 wherein said legs are made of a metallic material.

3. Tweezers for holding and positioning a nut or bolt head as recited in claim 1 wherein said legs are made of a polymeric material.

4. Tweezers for holding and positioning a nut or bolt head as recited in claim 1 wherein said locking mechanism is a slide apparatus which surrounds the legs of the tweezers.

5. Tweezers for holding and positioning a nut or bolt head as recited in claim 1 wherein said slide apparatus is made of a metallic material.

6. Tweezers for holding and positioning a nut or bolt head as recited in claim 1 wherein said slide apparatus is made of a polymeric material.

7. Tweezers for holding and positioning a nut or bolt head as recited in claim 1 wherein said locking mechanism comprises a slot located in a bias section of the tweezers and a locking pin, said locking pin is made of a metallic material.

8. Tweezers for holding and positioning a nut or bolt head as recited in claim 1 wherein said locking mechanism comprises a slot located in a bias section of the tweezers and a locking pin, said locking pin is made of a polymeric material.

9. Tweezers for holding and positioning a nut or bolt head as recited in claim 1 wherein said locking mechanism comprises a bias section in the legs of the tweezers.

10. Tweezers for holding and positioning a nut or bolt head as recited in claim 1 wherein said bend sections comprises substantially 120 degrees.

11. Tweezers for holding and positioning a nut or bolt head as recited in claim 1 wherein said bend sections comprises substantially 90 degrees.

12. Tweezers for holding and positioning a nut or bolt head as recited in claim 1 wherein said bend sections comprises a range from 90 degrees to 200 degrees.

13. Tweezers for holding and positioning a nut or bolt head as recited in claim 1 further including an extension engaged and substantially secured to said proximal end of said tweezers.

14. Tweezers for holding and positioning a nut or bolt head as recited in claim 13 wherein said extension is fabricated from a polymeric material.

15. Tweezers for holding and positioning a nut or bolt head as recited in claim 13 wherein said extension is fabricated from a metallic material.

16. Tweezers for holding and positioning a nut or bolt head comprising:
a pair of flexible legs fixedly joined at their proximal ends, each said leg having a distal end opposite a proximal joint, a first leg having a first distal end having a first partial polygonal jaw and a second leg having a second distal end having a second partial polygonal jaw;
said partial polygonal jaws comprising a plurality of bend sections, said bend sections result in a configuration that forms around at least two sides of a nut or bolt head, said tweezers having the function to hold and secure said nuts or bolt heads in areas of difficult accessibility; and
a locking mechanism embracing said legs to slidably engaging said first and second leg so that when moved from a proximal position to a distal position, said locking mechanism flexes said legs together.

17. Tweezers for holding and positioning a nut or bolt head as recited in claim 16 wherein said legs are made of a metallic material.

18. Tweezers for holding and positioning a nut or bolt head as recited in claim 1 wherein said legs are made of a polymeric material.

19. Tweezers for holding and positioning a nut or bolt head as recited in claim 16 wherein said locking mechanism is a slide apparatus which surrounds the legs of the tweezers.

20. Tweezers for holding and positioning a nut or bolt head as recited in claim 16 wherein said slide apparatus is made of a metallic material.

21. Tweezers for holding and positioning a nut or bolt head as recited in claim 16 wherein said slide apparatus is made of a polymeric material.

22. Tweezers for holding and positioning a nut or bolt head as recited in claim 16 wherein said locking mechanism comprises a slot located in a bias section of the tweezers and a locking pin, said locking pin is made of a metallic material.

23. Tweezers for holding and positioning a nut or bolt head as recited in claim 16 wherein said locking mechanism comprises a slot located in a bias section of the tweezers and a locking pin, said locking pin is made of a polymeric material.

24. Tweezers for holding and positioning a nut or bolt head as recited in claim 16 wherein said locking mechanism comprises a bias section in the legs of the tweezers.

25. Tweezers for holding and positioning a nut or bolt head as recited in claim 16 wherein said bend sections comprises substantially 120 degrees.

26. Tweezers for holding and positioning a nut or bolt head as recited in claim 16 wherein said bend sections comprises substantially 90 degrees.

27. Tweezers for holding and positioning a nut or bolt head as recited in claim 16 wherein said bend sections comprises a range from 90 degrees to 200 degrees.

28. Tweezers for holding and positioning a nut or bolt head as recited in claim 16 further including an extension engaged and substantially secured to said proximal end of said tweezers.

29. Tweezers for holding and positioning a nut or bolt head as recited in claim 28 wherein said extension is fabricated from a polymeric material.

30. Tweezers for holding and positioning a nut or bolt head as recited in claim 28 wherein said extension is fabricated from a metallic material.

31. Tweezers for holding and positioning a nut or bolt head comprising:
a pair of flexible legs fixedly joined at their proximal ends, each said leg having a distal end opposite a proximal joint, a first leg having a first distal end having a first partial polygonal jaw and a second leg having a second distal end having a second partial polygonal jaw;
said partial polygonal jaws comprising a plurality of bend sections, said bend sections result in a configuration that forms around at least two sides of a nut or bolt head, said tweezers having the function to hold and secure said nuts or bolt heads in areas of difficult accessibility; and
said legs having a bend with a proximal section and a distal section, wherein said legs are biased to force said first and said second partial polygonal jaws towards each other.

32. Tweezers for holding and positioning a nut or bolt head as recited in claim 31 wherein said tweezers are unbiased and move said first and said second partial polygonal jaw away from each other when pressure is applied to said proximal sections of said legs.

33. Tweezers for holding and positioning a nut or bolt head as recited in claim 31 wherein said legs are made of a metallic material.

34. Tweezers for holding and positioning a nut or bolt head as recited in claim 31 wherein said legs are made of a polymeric material.

35. Tweezers for holding and positioning a nut or bolt head as recited in claim 31 wherein said bend sections comprises substantially 120 degrees.

36. Tweezers for holding and positioning a nut or bolt head as recited in claim 31 wherein said bend sections comprises substantially 90 degrees.

37. Tweezers for holding and positioning a nut or bolt head as recited in claim 31 wherein said bend sections comprises a range from 90 degrees to 200 degrees.

38. Tweezers for holding and positioning a nut or bolt head as recited in claim 31 further including an extension engaged and substantially secured to said proximal end of said tweezers.

39. Tweezers for holding and positioning a nut or bolt head as recited in claim 38 wherein said extension is fabricated from a polymeric material.

40. Tweezers for holding and positioning a nut or bolt head as recited in claim 38 wherein said extension is fabricated from a metallic material.
